(19) United States
(12) Patent Application Publication
(10) Pub. No.: US 2006/0261181 A1
(43) Pub. Date: Nov. 23, 2006

(54) Backpack sprayer

(76) Inventor: Pedro Wirz, Jalisco (MX)

Correspondence Address: JONES DAY, 555 SOUTH FLOWER STREET FIFTIETH FLOOR, LOS ANGELES, CA, 90071, US

(21) Appl. No.: 11/088,483

(22) Filed: Mar. 24, 2005

(51) Int. Cl. A01G 25/09; B05B 9/00; B05B 3/18; B05B 9/03

(52) U.S. Cl. 239/146; 239/722; 239/149

(57) ABSTRACT

A backpack sprayer having a tank, an interior pressure chamber, and a piston assembly that is used to draw fluid into the pressure chamber and also to pressurize the chamber so as to expel the fluid under pressure, which piston assembly is connected by a linkage assembly to a handle bar that is manually operated by the operator of the sprayer to cause movement of the piston within a piston cylinder, the improvement including a piston cylinder cap that attached to the end of the piston cylinder and restrains downward movement of the piston arm.

### BACKGROUND OF THE INVENTION

This invention relates generally to a mechanical pumping device that utilizes a piston mechanism to create pressure within a confined space. In particular, this invention pertains to such a device that is particularly well adapted for use in a manually-operated backpack sprayer.

Just about every home, garden, landscape, farm, ranch and business requires, at one time or another, the application of a liquid-based substance in a localized way. For example, in and around every home isolated plants may need to be watered that cannot be easily watered with a garden hose, or an herbicide, pesticide, fungicide, fertilizer or other chemical agent may need to be applied. Such applications are an almost daily requirement on most farms and ranches, and around many homes and business.

For large applications, motorized spraying units on wheeled vehicles are commonly used. But there are innumerable instances in which the size or location of the job does not permit the use of such large equipment. For these type applications, a device that is typically known as a “backpack sprayer” has become ubiquitous.

As the name suggests, the backpack sprayer is one that is designed and constructed so as to be attachable to the back of the operator, much like the backpacks used by hikers and school children. It generally has a three- to five-gallon leak-proof tank that is contoured to rest comfortably against the operator's back, straps that usually slip over the operator's shoulders and a waist strap for correctly positioning and securing the device snuggly to the operator. The tanks also normally have a large, selectively openable and resealable opening on its upper surface (relative to when the tank is in place on the operator's back), through which the liquid-based material can be added to the tank.

At the other end of the tank (that is, the bottom of the tank when it is in place on the operator's back) are normally situated the “working” parts of the sprayer—the pumping and spraying mechanisms. These normally include some form of a piston-based mechanism for generating increased air pressure within a pressure chamber within a tank, and a handle bar, typically 18 inches to 2 feet in length, attached to the piston-based mechanism and extending forwardly from the tank (relative to the operator wearing the tank) that the operator manually operates with one hand in an up-and-down motion to cause some linkage assembly to rotate so that movement of the handle bar is thereby communicated to the piston.

A length of flexible hose through which the now-pressurized fluid contents are sprayed is also typically attached to the tank in that bottom area, and the distal end of that hose is usually equipped with a hand-operated valve and nozzle by which the operator directs the spray as desired. So, once the backpack sprayer is filled with the desired fluid, and it is properly secured to the operator, the operator uses one hand to move the handle bar in an up and down motion to pressurize the fluid, and the other hand to hold, activate and direct the valve-and-nozzle end of the hose to control and direct the spray.

Although there are various different mechanisms employed for pressurizing the contents of the tank, one often used, and the one which is used in the preferred embodiment displayed here, involves the use of a separate pressure chamber within the tank, into which liquid from the tank is drawn, and then pushed out under pressure through the hose that is attached to the pressure chamber. In this type device, the piston assembly is attached to the separate pressure chamber. Down-stoke on the piston (that is, pulling up on the handle bar) pulls fluid from the large tank into the piston cylinder chamber through a one-way valve. Up-stroke of the piston (that is, pushing down on the handle bar) pushes and pressurizes the fluid into the pressure chamber. Additional up and down strokes can be utilized to both push more fluid into and increase the pressure within the pressure chamber. Accordingly, the operator has the option of more or less continuous pumping of the handle bar while keeping the hose valve open to create a more or less steady stream of fluid at constant pressure, or, repetitively pumping of the handle bar while keeping the hose valve closed, which will create more fluid and greater pressure, thereby allowing for a subsequent spray of fluid that is initially released at higher pressure, and is sustained longer in between handle-bar pumping sessions, but at a steadily decreasing flow rate.

Such backpack sprayers are not new. In fact, the earliest patent known to have issued for what is now called a backpack sprayer issued well over 100 years ago in 1888 (U.S. Pat. No. 383,261). Since then, and certainly in recent years, quite a number of patents have issued relating to improvements in the design of backpack sprayers. For example, representative of such patents are U.S. Pat. Nos. 4,768,714, 4,798,333, 5,478,015, 5,636,791, 5,671,884, 5,775,543, 5,785,245, 5,984,199, and 6,412,707.

As is the case with most personal, portable mechanical devices intended for home and commercial use, the primary design goals, in no particular order, are: performance; reliability; durability; ease of use; light weight; low cost; and ease of manufacture. In the case of backpack sprayers, these are particularly important. First, because the sprayer is worn by the operator in all types of weather, any leakage will be uncomfortable at least (no one likes to have liquid spilled down the back of their pants, particularly so in cold weather), and could be dangerous at most if the liquid being sprayed is a chemical that may present health risks to the operator if he or she is unduly exposed to the chemical. Therefore, the sprayer must not only be capable of leak-free operation when it leaves the factory, it must remain leak-free during its lifetime of use, and these devices are expected to have a lengthy lifetime. Also, the “use” to which these sprayers are most often put can create challenges for the designer to meet the design of goal of long-term durability and reliability while maintaining acceptable cost, ease of manufacture and resultant weight. These sprayers are most often used in commercial settings, by workmen who may not be always concerned with the proper care and use of the machine. The sprayers may therefore be mishandled from time t0 time, not only during use but also after use when being stored or transported.

In use, the power that some operators can generate manually on the end of the handle bar is enormous, putting tremendous stress on the linkage and piston assemblies. For example, some operators desire to create extremely high pressure within the pressure chamber. Accordingly, they will push and pull on the handle bar numerous times before ejecting any liquid. Of course, as the pressure within the chamber builds, the force required to move the piston increases as well. Before long, the operator has to apply tremendous force to the end of the handle bar. Because of the leverage that is obtainable given the length of the handle and fact that the handle bar is attached to the linkage at one end, and the operator applies force at the other end, the resultant force that can be generated on the piston assembly can be huge. Therefore, those assemblies must not only be durable and reliable, but must also be able to maintain those characteristics in the face of rigorous usage over a long period of time.

It would of course be possible to design the linkage and piston assemblies to be entirely constructed of large, heavy gauge material that could be expected to withstand such rigorous use and treatment. However, as mentioned above, the preferred design goals include low cost, ease of manufacture, and light weight. Therefore, the use of large amounts of steel or other heavy gauge material is ultimately counterproductive.

For example, the use of plastic (usually polyethylene) components in backpack sprayers is common, as plastic provides for reasonable strength and durability on the one hand, and for light weight, ease of manufacture and low cost on the other. Some of the components that are often made of plastic include the tank, the pressure chamber, the tank opening and closing apparatus, the piston cylinder, and large portions of the piston itself.

But, while plastic does provide for reasonable strength and performance at low cost with light weight, it simply cannot generally withstand the forces generated by many operators. Therefore, a combination of plastic and steel or aluminum must be used.

One area in which steel or aluminum must be used in is the handle bar, and the piston and linkage assemblies. Because the piston cylinders in the sprayers can be quite large, it is undesirable to use steel or other heavy gauge material for the cylinder as that would add materially to cost and weight. But, the piston and cylinder, and the adjacent linkage, are where the greatest forces must be accommodated, and is also the area where damage and leakage can most readily occur.

Therefore, so as to be able to use plastic for portions of the piston and the entirety of the piston cylinder, means must be provided that restrict the movement of the piston within the cylinder. This is made doubly important because of the way in which the piston is caused to move within the cylinder. In other words, the piston is made to move by manual pressure placed upon the end of the handle bar. That up-and-down movement of the handle bar in turn causes the main linkage member that is attached to the proximal end of the handle bar and also to the piston to rotate about its axis. That axial rotational movement is communicated to the piston via a piston arm that is attached at one end to the linkage member and at its other end to the piston. The linkage member and the piston arm rotate, but linear movement of the piston within the piston cylinder is desired for proper operation of the device. Therefore, the amount of distance that the piston is allowed to move within the piston cylinder must be carefully controlled. Otherwise, the piston is pulled out of alignment with the cylinder resulting in one or more undesirable things: 1) the liquid in the tank may leak out of the device onto the operator; 2) the rubber seal on the head of the piston may become unattached; and 3) in extreme cases, the piston and/or the piston cylinder cracks, rendering the device useless until repaired.

For this reason, various means and methods have been designed for limiting the piston's travel within the piston cylinder. Two such ways that the inventor has tried before include a large R-shaped metal pin that was inserted strategically within the handle bar and linkage assemblies such that the ends of the pin would impact the tank upon the maximum desired up and down movement of the handle so as to restrict movement of the linkage. (See FIG. 7A). That, however, proved unworkable because even a large metal pin could be bent if sufficient force were applied to the handle bar by the operator. Also, even if not bent in one event, the wear and tear on the pin over time would be sufficient to deform it sufficiently so that it permitted more than the desired movement of the piston. Instead of a metal pin, the inventor also tried a hard plastic wedge that was strategically attached to the handle to similarly restrict its movement within allowable tolerances. (See FIG. 7B). This too proved unworkable as the force that could be generated by some operators over time would cause sufficient deformation of the wedge that it ceased to function properly.

While these prior art devices are useful to a degree, they still suffer from certain drawbacks in that they did not provide sufficient durability and reliability. Therefore, there existed a need in the art for an improved way to properly limit the piston's movement within the cylinder, and to do so in a way that does not add materially to the cost or weight of the device.

### SUMMARY OF THE INVENTION

This invention provides such an improved device with an elegant solution to the problem that not only effectively and appropriately limits the movement of the piston within the cylinder, but also provides other benefits as well, such a protecting the piston and piston cylinder from physical damage, limiting their exposure to dust and other unwanted elements, and providing some protection to the operator and others in close proximity to the piston linkage from injury.

To accomplish these multiple goals, a piston cylinder cap is attached to the exposed end of the piston cylinder, leaving only enough space for the piston arm to operate. The cap is designed and constructed so as to act as a stop for the piston during its down stroke.

In the preferred embodiment, for ease of construction and assembly, the piston cylinder cap is held into the correct axial and lateral position on the cylinder by being designed so that it has an interior area that fits snuggly up against the end of the cylinder when properly positioned, a pair of exterior tabs that reside above and abut the upper edge an exterior projection (or projections) on the cylinder, and an appropriately sized and shaped open area in the wall of the cap, such that the sidewalls of the cap on either side of the open area laterally abut against the lateral edges of the exterior projection (or projections). That interior end of the cylinder cap also has a number of upwardly-extending interior flanges with intermediate pegs around its lower interior periphery. The flanges are sized, shaped and placed away from the cap interior so as to act as a guide for the exterior wall portion of the piston body on its down stroke, and the intermediate pegs act as a stop for the piston when the exterior bottom edge of the of the piston comes into contact with them at the desired maximum down stroke of the piston. The cap is also designed and constructed so as to have an integral channel within which the piston arm generally resides.

Therefore, in the preferred embodiment of this invention, the combination of the pegs on the bottom of the cap on the one hand, and the tabs and open area of the cap in conjunction with the exterior projection (or projections) on the cylinder on the other hand, act together to provide the restraining function that can withstand the forces generated by even the biggest, strongest and most aggressive operators on the down stroke of the piston, whether in a single event or repetitively over a long period of time.

There are, of course, other means by which the same inventive concept can be implemented. In the way of example and not limitation, the cap can be held in proper position on the piston cylinder through a myriad of other well-known ways, such as any other arrangement of projections, tabs, openings, mortise and tenon arrangements, threads, etc., or combination thereof, or by being glued or welded, or having an exterior flange that resides between two exterior projections on the cylinder, or being attached directly to the tank or the piston linkage. In addition, ways in which the cap can limit the movement of the piston and piston arm would include other tab and stop designs, and other arrangements what would be functionally equivalent to the interior flanges and pegs disclosed in the preferred embodiment of the cap. For example and not by way of limitation, instead of single flanges with intermediate pegs, the flanges could be extended such that they become a one-piece skirt and the pegs become a circular element instead of individual pegs; or they could be removed and the bottom of the cap itself could be used as the mechanism to restrain downward movement of the piston.

### DESCRIPTION OF THE FIGURES

FIG. 1 is a perspective view of the preferred embodiment of this invention, shown in right-side-up position as it would be when attached to the back of the operator. This drawing is in partial “exploded” format, showing the piston cap removed from the piston cylinder.

FIG. 2 is an isolation, perspective, partially exploded view showing the piston assembly, linkage assembly, and cap in greater detail. As in FIG. 1, the cap is still shown as removed from its intended position on the piston cylinder.

FIG. 3 is a side, cross-sectional view taken along Line 3-3 in FIG. 2, showing the proper alignment of the piston assembly (piston, piston arm and piston cylinder) upon the up-stroke of the piston. As will be noted, the piston cap is not shown.

FIG. 4 is similar to FIG. 3, but shows what happens to the alignment of the piston and piston cylinder if the piston arm is allowed to rotate too far during the down stroke of the piston. As can be appreciated, further rotation of the piston arm would cause even greater misalignment and localized pressure by the piston on one side of the piston chamber that could cause either it or the piston to break.

FIGS. 5A and 5B are similar views to FIGS. 3 and 4, but show the piston, piston arm and piston cylinder with the cap installed. FIG. 5A shows the piston in fully up-stroke position; whereas 5B shows the piston in fully down-stroke position, with its down-stroke travel within the piston cylinder being restrained by the cap.

FIGS. 6A, 6B and 6C show various views, respectively the side, front and top views, of the cap and the flange/peg arrangement in isolation.

FIGS. 7A and 7B show in isolation two of the prior art ways in which restriction of the rotational movement of the piston linkage was attempted.

### DESCRIPTION OF THE PREFERRED EMBODIMENT

Throughout this Specification and the attached Claims, reference to direction such as “top,” “above” or “upwardly” etc. shall refer to the upward direction for the components as oriented and shown in the Figures; whereas references to “bottom,” “down” and “below” etc. shall refer to the downward direction for the components as oriented and shown in the Figures, which is how the sprayer would be oriented when attached to the back of the operator ready for use. References to “front” or “side” or “back” are used relative to the operator upon whom the sprayer is attached. For example, the “front” refers to the side or direction facing in the same direction as the operator would be facing.

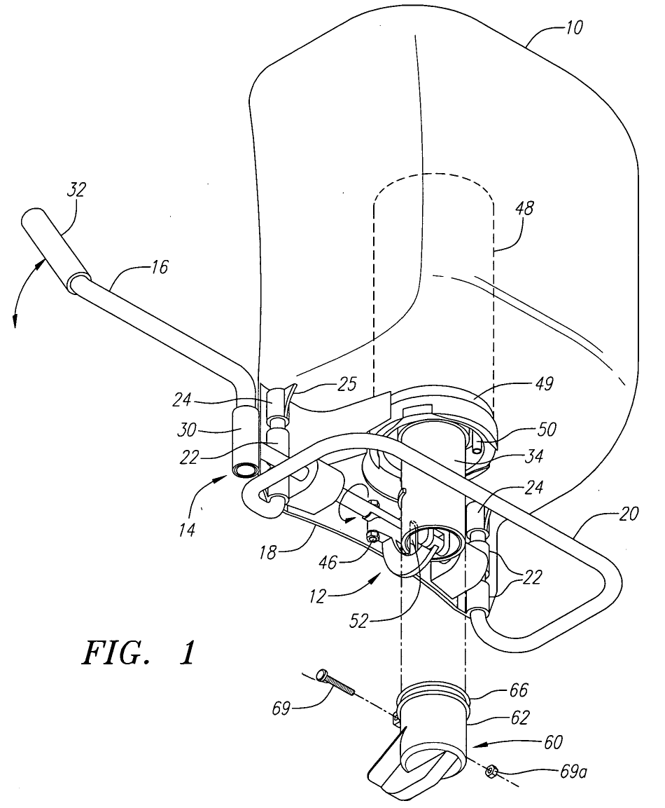

Looking at FIG. 1, it is seen that the preferred embodiment of this invention has the usual primary components for a high-end backpack sprayer—the tank 10, the piston assembly 12, the linkage assembly 14, and the handle bar 16. (The straps that are used to secure the sprayer to the operator are not shown, but could be of any design that provided for comfortable and secure attachment. Also not shown is the upper side of the tank 10 where the fill opening and cap are located. Those too can be of any conventional design, and is most often a fairly wide opening of 5 or 6 inches in diameter, with a filter and screw-on cap. The caps usually also include a venting mechanism to prevent dangerous build-up of pressure or fumes within the tank itself.).

In this embodiment, the tank is of one-piece molded construction of a polyethylene or other suitable material. The tank also has an integrally formed downwardly extending flat portion 18 which is used for additional stabilizing area against the operator's back, and as the surface to which the linkage assembly 14 is attached. Also in this embodiment, a metal tube frame 20 is attached at either side of the bottom of the tank 10, and extends outwardly and rearwardly therefrom, providing the dual function of protecting the linkage and piston assemblies 14 and 12 from damaging blows, and acting as a stand upon with the sprayer can be placed upright when not in use. In this embodiment, the tube frame 20 is very easily but securely attached to the tank 10 by inserting each end of the tube frame 20 through two bosses 22 formed integrally with the flat portion 18 and into a terminal 24 that is formed integrally with both the flat portion 18 and the underside of the tank 10. The terminals 24 each also have a flange 25 that is attached to it and to the underside of the tank 10 for even greater stability and strength. The size of the apertures in the bosses 22 and the terminals 24 are such that once the ends of metal tube frame 20 is inserted through and into them, the metal tube 20 is held very snuggly in place. The ends of the metal tube frame 20 can also be heated before insertion to ease insertion and to secure them more tightly after insertion. The ends of the metal tube frame 20 can also be formed integrally with the formation of the tank 10 itself by inserting the tube ends an appropriate distance into the mold (not shown) for the tank 10 and then molding the tank 10 around the ends of the tube fame 20.

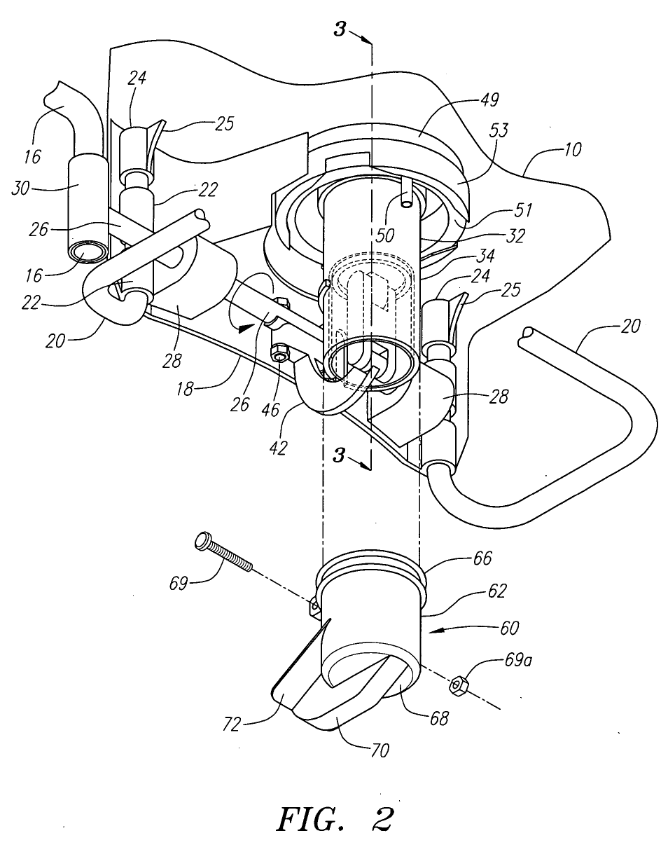

Looking now at FIG. 2, the components of the linkage and piston assemblies 14 and 12 are shown in isolation and enlarged for easier viewing. Looking first to the linkage assembly 14, it comprises a hollow metal spindle 26 that is rotatably attached to the flat portion 18 of the tank 10 via two large spindle bosses 28 that are also constructed of a polyethylene material and formed integrally with the tank 10. The spindle 26 should fit snuggly, but still be freely rotatable within the spindle bosses 28. Because the spindle 26 will be held in proper alignment by the piston assembly 12 as hereinafter described, it is not absolutely necessary to provide for other alignment or restraining means so as to keep spindle 26 properly positioned within the spindle bosses 28, but such means can be easily provided, for example by use of a cotter key or dimples on the outside of the spindle 26 adjacent the spindle boss 28.

One end of the spindle 26 terminates at the outer edge of one boss 28. The other end of the spindle 26 extends a distance beyond the other boss 28 where it is welded to a short hollow segment 30 at a right angle thereto. Hollow segment 30 acts as the housing into which fits one end of the handle bar 16. Preferably, the outside diameter of this end of the handle bar 16 is very close to the inside diameter of the segment 30, so that the end of the handle bar 16 can slide easily but snuggly into it. Any conventional means can be used to secure the handle bar 16 within the segment 30, such as a simple pin that is inserted through aligned holes in each (not shown).

The handle bar 16 is elongate and is sized and shaped so that it extends forwardly (relative to the user when the sprayer is in position on his or her back), and is positioned there in an ergonomically appropriate way so that the operator can easily grasp the distal end of the handle bar (equipped with a handle grip 32) so that the operator can easily grip the end of the handle bar 16 and move it up and down. The sprayer as shown is a left-handed unit in which the handle bar 16 would be moved by the left hand of the operator. As can be appreciated, a right-handed unit can be constructed simply by having the handle bar 16 and segment 30 attached on the other side of the unit.

Turning now to the piston assembly 12, which is best seen in FIG. 2, it comprises a piston cylinder 34, a piston 36, an H-link 40 that is rotatably attached at one end to the bottom of piston 36, and rotatably attached at its second end to a first end of curved piston arm 42. The other end of piston arm 42 has an elongate attachment portion 44 that mates with spindle 26, to which it is securely attached by any suitable means, as shown here via nuts and bolts 46 that extend through appropriately sized and aligned holes in spindle 26 and attachment portion 44.

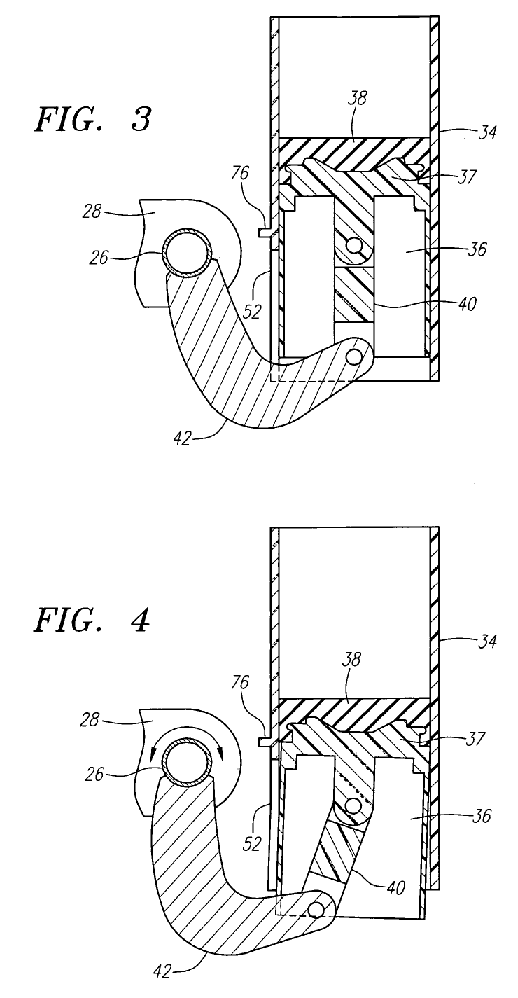

As best seen in FIG. 3, the piston cylinder 34 and the piston 36 both are cylindrical in shape and of course have corresponding interior and exterior diameters, respectively. The body of piston 36 preferably is fairly long so as to provide significant surface contact with the piston cylinder 34. In addition, the top portion 37 of the piston 36 is fitted with a gasket 38 of a rubber or neoprene type material that will form a fluid-tight seal against the sides of the piston cylinder 34, but still be slideable within the cylinder. A circumferential metal spring (not shown) resides within the gasket 38 so as to create and maintain uniform outward pressure on the gasket 38 and thereby to maintain its seal with the piston cylinder 34.

The piston cylinder 34 is air-tightly and securely inserted into the bottom of, and is in fluid communication with, pressure chamber 48. Pressure chamber 48 is in turn air-tightly and securely inserted into an appropriately-sized collared aperture 49 in the bottom of, and is in fluid communication with the interior space of, the tank 10. Appropriately placed O-rings (not shown) are used around the outside of the piston cylinder 34 and pressure chamber 48 so as to create a leak-proof seal. A small, short hollow tube 50 is in fluid communication with the interior of the pressure chamber 48 and extends a short distance beneath it for attachment to the hose (not shown). The bottom of the pressure chamber 48 has an outwardly extending circumferential flange 51 that mates with a circumferential flange (not shown) on the collared aperture 49 in the bottom of tank 10. A removable circular bracket 53 encases the mated flanges on the pressure chamber and on the collared aperture (not visible) and is tightened via nut and bolt means (not shown) to securely hold the pressure chamber 48 immovably in place within the tank 10, and concomitantly, to hold the piston cylinder 34 immovably in place within the pressure chamber 48. A simple mortise and tenon arrangement (not shown) consisting of a small slot in flange 51 that fits snugly over a slight downwardly extending projection on collared aperture 49 prevents the pressure chamber 48 from rotating once fully inserted and the bracket 53 secured in place.

As best seen in FIGS. 1 and 2, the piston cylinder 34 has a narrow slot 52 formed in the bottom end thereof and extending a short distance up the piston cylinder 34. The piston arm 42 moves within slot 52 during movement of the piston 36, so slot 52 has to be sufficiently large and of sufficient length to accommodate that movement, but is preferably no larger than need be so as to guard against the introduction of unwanted material into the piston cylinder 34.

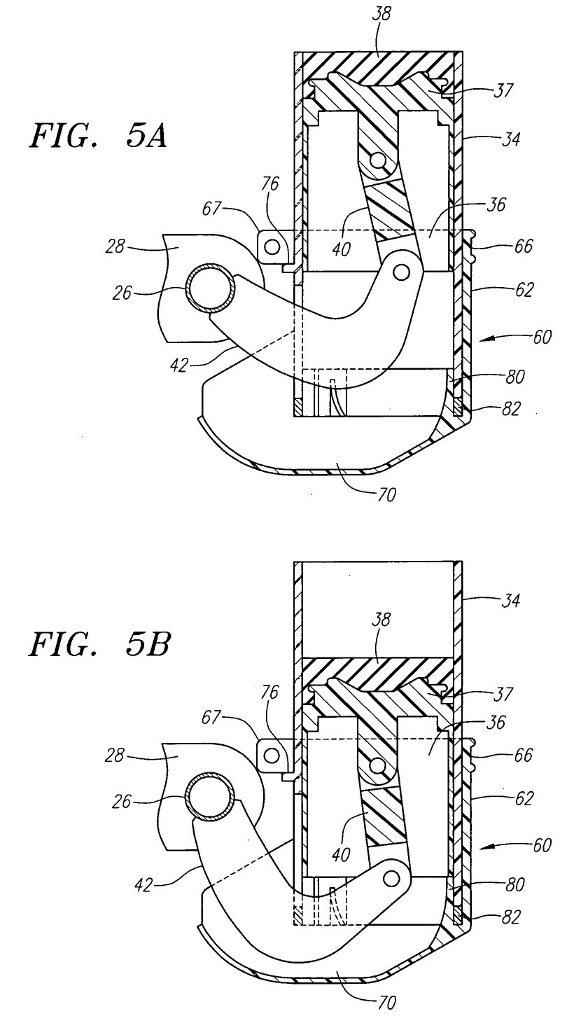

It will now be appreciated that in the sprayer herein described, movement of the handle bar 16 up and down by the operator causes rotational movement of spindle 26. Rotational movement of spindle 26 within bosses 28 is in turn communicated to and causes rotational movement of curved piston arm 42. As piston arm 42 rotates, its end that is attached to the H-link 40 moves up and down, as well as side to side. The H-link 40, however, absorbs the side to side movement such that only the up and down movement of the piston arm 42 is communicated to piston 36, causing it to move up and down within cylinder 34. This action is best seen in FIGS. 3, 4 and 5A and B.

As described above, movement of the piston 36 during up-stroke is controlled by the top of the cylinder 34, although in operation the piston typically does not extend that far on the up-stroke. Movement of the piston 36 during down stroke is controlled by means of the piston cylinder cap 60.

The piston cylinder cap 60 is best seen in FIGS. 1, 2, 5A and B, and 6A to C. In this preferred embodiment, the cap 60 is of unitary construction, made of any suitable material, such as polypropylene. It is has a cylindrical, elongate side portion 62, and largely hollow interior body portion 64 that is sized to fit snugly over the end of piston cylinder 34 for a significant and material distance (here about 2½ inches) for secure and stable attachment. The top portion of the cap has a slit collar 66 and a pair of opposing end portions 67 that each have a hole through which bolt 69 can be inserted, and against which the head of the bolt 69 and the nut 69a can be tightened so as to tightly secure the cap 60 to the cylinder 34.

The bottom portion 68 of the cap 60 is completely enclosed, but has formed integrally in it a piston arm channel 70 that extends downwardly and outwardly therefrom. In order to provide both lateral and other support for that portion of the channel 70 that extends outwardly from the remainder of the cap 60, a flange 72 extends from both sides of the exterior surface of the channel 70 to the exterior of the side portion 62.

On one side of the cap 60 there is an open area 74 that extends from above the flange 72 to the collar 66. The width of the open area 74 is such that it will fit over and abut against either end of outwardly extending projection 76 on the exterior of the cylinder 34. By having this open area 74 abut the projection 76 on either side thereof, the cap 60 is held in place laterally, and by having the collar 66 reside and abut against the upper surface of the projection 76, the cap 60 is held in place on the cylinder 34 axially. Through appropriate sizing and placement of the projection 76 and the open area 74, the piston arm channel 70 is held in proper alignment with the piston arm 42, and with the slot 52 in the piston cylinder 34. The size, shape and arrangement of the opening, tabs and projections shown here are a preferred embodiment only. Other such arrangements could be easily substituted, as the important thing here is that the cap be held in place laterally (so that it does not twist on the cylinder) and even more importantly, that it does not move axially downward on the cylinder, but is held in position so that it effectively operates as a stop for the down stroke of the piston at its maximum desired travel, and that it is able repeatedly to withstand the force exerted by even the strongest and most aggressive operators.

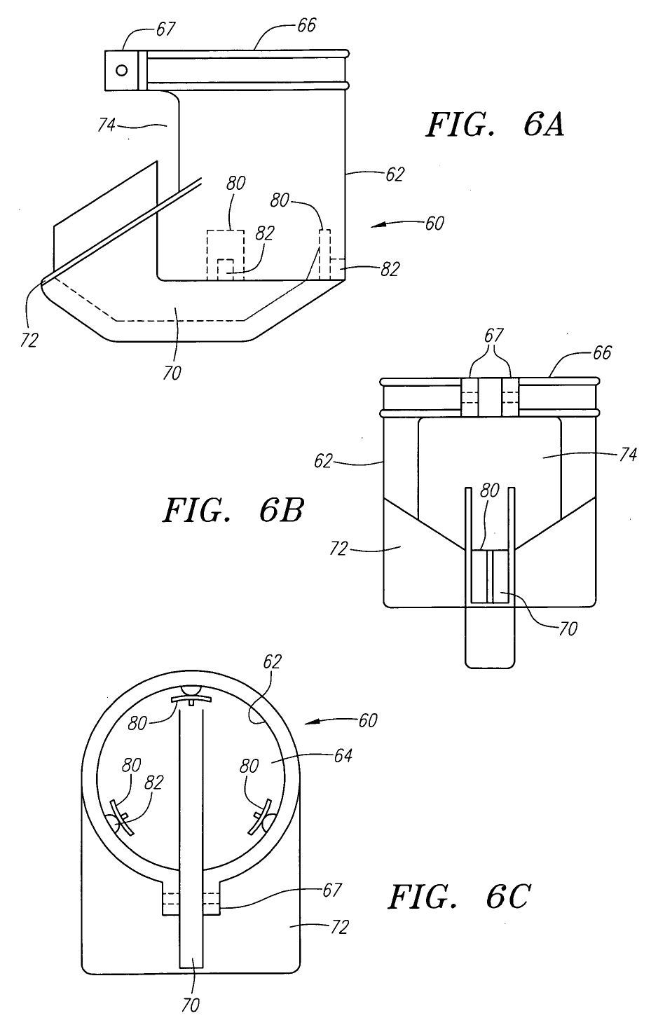

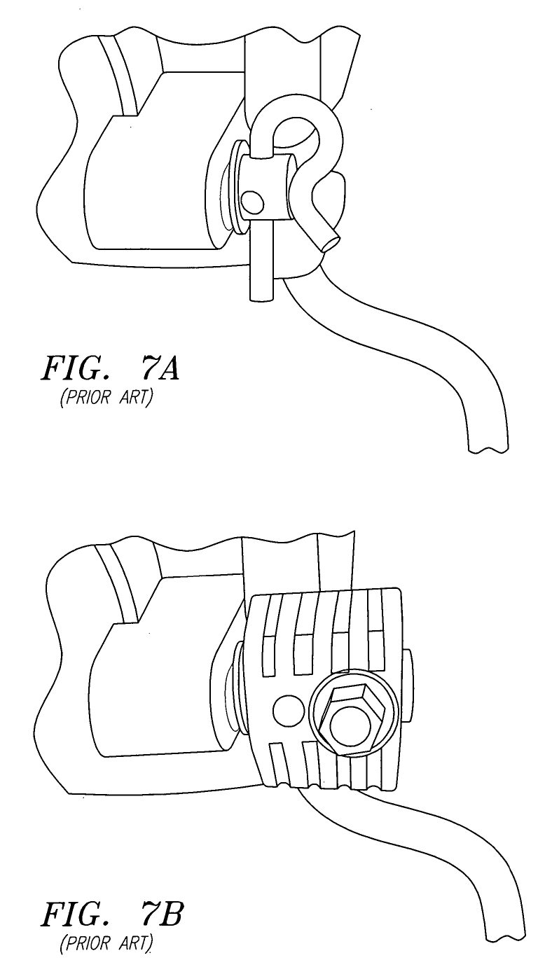

Looking at FIG. 6C, the interior section of the bottom portion 68 of the cap 60 has several useful features. First, it has a number of upwardly extending flanges 80 around its interior circumference, which flanges are separated from the side wall of the cap a distance that is equal to the side wall width of the cylinder body, so that when the cap is in place on the cylinder, the flanges abut the interior of the cylinder body and thus act as a holding member. Also, within the area between each flange 80 and the side wall of the cap 60 is a peg 82 that acts as a stop for the bottom of cylinder 34 upon full insertion of the cap 60 on the bottom of the cylinder 34. The tops of each of the flanges 80 also act as the “stop” against which the bottom edge of the piston abuts upon the maximum down stroke of the piston 36. In other words, the relative sizes and placements of the various components in the piston assembly and the cap are designed so that the down stroke of the piston 36 is stopped when the bottom of the piston 36 comes into contact with the multiple flanges 80. Therefore, the forces generated are spread amongst these various contact points such that no one of them is over-stressed. Also, in this arrangement, the force on the flanges 80 is a direct force, rather than an indirect force as was the case in the prior art attempts to limit movement of the piston.

Cap 60 thus provides a number of important functions. First, the cap protects the piston arm, piston cylinder and H-link from damaging blows; second, the cap substantially encases the movement of the piston arm to prevent fingers or garments from becoming entangles and perhaps injured; third, the cap substantially prevents dust and foreign objects from entering the piston cylinder where it might adversely affect the operation of the piston assembly or the piston itself; fourth, the channel helps guide the movement of the piston arm to keep it properly aligned so as to maintain efficiency and not place unwanted torque on the piston or piston cylinder; and fifth, the cap restrains downward movement of the piston so as to maintain the piston's travel within the cylinder to allowable tolerances so as not to cause leakage or damage.

Although preferred embodiments have been shown and described, the disclosed invention and the protection afforded by this patent are not limited thereto, but are of the full scope of the following claims, and equivalents thereto.

I claim:

1. In a backpack sprayer having at least a tank for holding a fluid, a pressure chamber in fluid communication with the tank, a piston cylinder in fluid communication with the pressure chamber, one end of the piston cylinder being exposed and extending a distance below the tank, a manually-operated piston movable within the piston cylinder to move fluid into the pressure chamber from the tank and out of the pressure chamber via an attached hose, and a handle bar linked to the piston by a linkage assembly that includes at least a piston arm, such that movement of the handle bar causes the piston to move within the piston cylinder, the improvement comprising a cap attached to the exposed end of the piston cylinder, the cap being sized and shaped and securely attached to the end of the piston cylinder so that as attached it acts to restrain the downward movement of the piston within the piston cylinder beyond a pre-determined distance.

2. The invention of claim 1 wherein said cap has one or more interior flanges arranged around its interior circumference that are sized and shaped such that the piston contacts them during the down stroke of the piston at a pre-determined point.

3. The invention of claim 1 wherein said cap has a piston arm channel within which said piston arm partially resides.

4. The invention of claim 1 wherein said cap has one or more interior flanges arranged around its interior circumference that are sized and shaped such that the piston contacts them during the down stroke of the piston at a pre-determined point, and has a piston arm channel within which said piston arm partially resides, and against the bottom of which the piston arm contacts when the piston arm has moved downwardly a pre-determined distance.

5. The invention of claim 1 wherein said cap is attached to said piston cylinder by means of an opening on at least one side of the cap which at least partially mates with a projection on the cylinder.

6. The invention of claim C5 wherein said cap has a split collar that is securely attached above an appropriately-sized projection on cylinder.

7. The invention of claim C6 wherein when said split collar is attached to the cylinder as described, the end of the cylinder abuts firmly against the interior bottom portion of the cap.

8. In a backpack sprayer having at least a tank for holding a fluid, a pressure chamber in fluid communication with the tank, a piston cylinder in fluid communication with the pressure chamber, one end of the piston cylinder being exposed and extending a distance below the tank, a manually-operated piston movable within the piston cylinder to move fluid into the pressure chamber from the tank and out of the pressure chamber via an attached hose, and a handle bar linked to the piston by a linkage assembly that includes at least a piston arm, such that up and down movement of the handle bar causes the piston arm to rotate upwardly and downwardly which in turn causes the piston to move upwardly and downwardly within the piston cylinder, the improvement comprising a cap attached to the exposed end of the piston cylinder, the cap being sized and shaped and attached to the end of the piston cylinder so that as attached it acts to restrain the downward motion of the piston arm.

9. The invention of claim C8 wherein said cap includes a piston channel within which the piston arm generally resides.
